(19) United States
(12) Patent Application Publication
(10) Pub. No.: US 2025/0052776 A1
(43) Pub. Date: Feb. 13, 2025

(54) Pipetting Device with a Removable Head

(71) Applicant: Hamilton Company, Reno, NV (US)

(72) Inventors: Charles Jacob Schmick, Sparks, NV (US); Cassidy Arthur Hebert, Sparks, NV (US)

(73) Assignee: Hamilton Company, Reno, NV (US)

(21) Appl. No.: 18/785,529

(22) Filed: Jul. 26, 2024

Related U.S. Application Data
(60) Provisional application No. 63/532,271, filed on Aug. 11, 2023.

(51) Int. Cl. G01N 35/10; G01N 35/00

(52) U.S. Cl. CPC G01N 35/10; G01N 35/0099

(57) ABSTRACT

A robotic pipettor with pipette heads that are less than 9 mm wide, contain the mechanical components for the dispense drive and tip coupling mechanism, and are designed such that a user can replace the heads without tools.

### CROSS-REFERENCE TO RELATED APPLICATION

This application claims priority under 35 U.S.C. Section 119(e) to co-pending U.S. Provisional Patent Application No. 63/532,271 entitled “Pipetting Device with Removable Head” filed on Aug. 11, 2023, the entire disclosure of which is incorporated herein by reference.

### FIELD

This invention pertains generally to pipetting devices, and more particularly to pipetting devices with removable heads where the heads can be removed without the use of tools.

### BACKGROUND

Pipette devices are used in a multitude of industries for the transfer of liquids to conduct experimental analysis. As such, pipette channels can vary in size.

Most current laboratory robotic pipettors have pipette channels and pipette heads that are larger than 9 millimeters (“mm”) wide, but the microplates they access are on 9 mm spacing. Some robotic pipettors on the market achieve 9 mm spacing by mounting the channels in an offset pattern. Other manufacturers remote mount certain components of the dispense drive to make the pipette head small enough to mount on 9 mm spacing.

Current pipette heads on the market either cannot be replaced by users or require the user to use tools to replace the heads.

A pipette head and a corresponding pipette channel form an axis. Typically, in current robotic pipettors, the motor for each axis is too large to nest on 9 mm spacing.

A number of prior pipetting devices exist. For example, the Hamilton Microlab Prep is a laboratory robotic pipettor that has user replaceable pipette heads that nest on 9 mm spacing. However, to replace these heads, the user must use tools to remove the head and connect the new head. In addition, only two pipette channels can nest on 9 mm spacing in this pipettor. The pipette heads on the Hamilton Microlab Prep are larger than 9 mm wide and in order for the channels to nest on 9 mm spacing the heads are offset from one another.

The Hamilton MagPip is a pipette channel produced by Hamilton Bonaduz, which is a pipette channel and pipette head that is less than 9 mm wide. This means any number of the MagPip can nest on 9 mm spacing. However, a customer cannot replace the pipette head.

The Seyonic OEM Single Channel MicroLiter is a pipette head produced by Seyonic that is less than 9 mm wide so any number of pipette heads can nest on 9 mm spacing. The user cannot replace the head without the use of tools, and the Seyonic OEM Single Channel Microliter pipette head does not have an integrated dispense drive. Instead, the Seyonic OEM Single Channel Microliter pipette head utilizes a remote mount pressure controller and valve manifold. The pipette head is coupled to the remote mount pressure controller and valve manifold with a small tube.

The Tecan Cavro Air Displacement Pipettor is a pipette head produced by Tecan that has a built in dispense drive and tip coupling mechanism. It is 17 mm wide though, so it cannot nest on 9 mm spacing, and the user cannot replace the head without the use of tools.

Hence, there is a need to overcome one or more of the significant shortcomings these prior devices.

In particular, there is a need for a robotic pipettor with pipette heads that are less than 9 mm wide, contain the mechanical components for the dispense drive and tip coupling mechanism, and are designed such that a user can replace the heads without tools.

### SUMMARY

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

According to various embodiments, the invention and disclosure herein describes a robotic pipettor with a pipette channel and a pipette head. In one embodiment, the pipette head is less than or equal to 9 mm wide, is customer replaceable without tools, and contains all mechanical components for the dispense drive and tip coupling mechanism.

In one embodiment, a latch and electrical connection fits in the small format of the pipette head. The latch can be operated by hand and the electrical connection is made and broken by the act of installing and removing the head, respectively. No secondary action of installing a connector is needed and no screws are needed to hold the pipette head in place.

Providing the ability for the user to replace the pipette head without tools makes the replacement of the pipette head easier and reduces down time for service.

This invention discloses a squeeze mechanism and dispense drive that uses a combination of a motor, a gearbox and a leadscrew that are small enough to fit the framework for 9 mm spacing but still provide accurate pipetting performance.

The squeeze mechanism uses a solenoid to move a drive ring of a tip coupling mechanism, such as a drive ring of a Hamilton CORE II tip coupler. The small size of the solenoid and dispense motor enables the pipette head to nest on 9 mm spacing.

The mechanical components of each axis are incorporated on the head. The electrical components, such as the CPU, power supplies, and motor driver chips are located on the pipette channel.

The dispense drive and tip coupling mechanism can be incorporated into the small form factor pipette head of this invention because the design of the pipette head has a better mechanical advantage than prior designs. By gaining more mechanical advantage and better efficiency, it is possible to use a smaller motor and solenoid that will fit within the pipette head of this invention.

Because the pipette head is less than or equal to 9 mm, any number of pipette heads can nest next to each other on 9 mm spacing.

For example, in one embodiment, a robotic pipettor is disclosed comprising a pipette head comprising a width; a pipette channel; and wherein the pipette head can be removed from the pipette channel without the use of tools.

In this embodiment, the robotic pipettor can further comprise a latch; a head electrical connector; and wherein the latch can be operated manually. The robotic pipettor can also further comprise the pipette head further comprising a top portion; the latch further comprising a push portion and a hook portion; the pipette channel further comprising a latch striker; and wherein the push portion of the latch moves the hook portion of the latch; and wherein the hook portion of the latch hooks over the latch striker of the pipette channel to attach the top portion of the pipette head to the pipette channel. The robotic pipettor can also further comprise a printed circuit board and wherein the head electrical connector is mounted on the printed circuit board. The robotic pipettor can also further comprise the pipette channel further comprising a channel connector and wherein the head electrical connector connects with the channel connector to establish an electrical connection between the pipette head and the pipette channel. The robotic pipettor can also further comprise the pipette channel further comprising a spine comprising a hook; the pipette heard further comprising a corner pin; and wherein the corner pin on the pipette head engages with the hook on the spine of the pipette channel to secure the pipette head to the pipette channel and to allow the pipette head to tilt away from the pipette channel when removing the pipette head from the pipette channel.

In this embodiment, the robotic pipettor can further comprise a dispense drive comprising a dispense motor comprising a gearbox, a lead screw, a leadnut, and a piston; a tip coupling mechanism; and a squeeze mechanism comprising a solenoid, a solenoid coupler, a spring, and a squeeze sleeve. The robotic pipettor can also further comprise wherein the solenoid has a width less than or equal to 7 mm and the dispense motor has a width less than or equal to 8 mm. The robotic pipettor can also further comprise wherein the dispense drive is a brushless DC motor and the gearbox is a 4 to 1 reduction gearbox.

In this embodiment, the robotic pipettor can further comprise a drive ring comprising an angle and wherein the angle is 11 degrees.

In this embodiment, the robotic pipettor can further comprise wherein the pipette head has a width less than or equal to 9 mm. The robotic pipettor can also further comprise wherein the pipette head is 8.25 mm wide.

In another example embodiment, a robotic pipettor is disclosed comprising a plurality of pipette heads, each pipette head in the plurality of pipette heads comprises a pipette channel and a width; wherein each pipette head of the plurality of pipette heads can be removed from the pipette channel without the use of tools; and wherein the spacing between neighboring pipette heads in the plurality of pipette heads is less than or equal to 9 mm.

In another example embodiment, a method for connecting a pipette head to a pipette channel is disclosed comprising tilting a pipette head back at an angle from a spine of a pipette channel; placing a corner pin of the pipette head onto a hook of a spine of the pipette channel; and tilting the pipette head towards the spine of the pipette channel until a latch connects with a latch striker and clicks into place.

In another example embodiment, a method for removing a pipette head to a pipette channel is disclosed comprising powering off a pipette channel; pressing a latch on the pipette head to release the pipette head from the pipette channel; tilting the pipette head away from the pipette channel; and lifting the pipette head up and away from the pipette channel to disengage a corner pin of the pipette head from a hook on a spine of the pipette channel.

### BRIEF DESCRIPTION OF THE SEVERAL VIEWS OF THE DRAWINGS

The foregoing summary, as well as the following detailed description of the disclosure, will be more fully understood by reference to the following drawings which are for illustrative purposes only, and are not intended to limit the scope of the present disclosure. Also, it is appreciable that the drawings are not necessarily to scale as some components may be shown to be enlarged or to be out of proportion relative to the size in actual implementation in order to more clearly illustrate one or more concepts of the present disclosure. In the drawings:

FIG. 1 is a first side view of an example embodiment of a robotic pipettor of the present invention.

FIG. 2 is a second side view of the example robotic pipettor in FIG. 1.

FIG. 3 is a first side view of an example embodiment of a pipette head of the present invention.

FIG. 4 is a second side view of the example pipette head in FIG. 3.

FIG. 5 shows the example pipette head in FIG. 3 partially attached to a pipette channel of the example robotic pipettor in FIG. 1.

FIG. 6 shows an example embodiment of the pipette channel of the robotic pipettor in FIG. 1.

FIG. 7 shows a cut away view of the pipette head in FIG. 3 in the squeeze position.

FIG. 8 shows an enlarged view of the coupling mechanism of the pipette head in the squeeze position shown in FIG. 7.

FIG. 9 shows a cut away view of the pipette head in FIG. 3 in the un-squeeze position.

FIG. 10 shows an enlarged view of the coupling mechanism of the pipette head in the un-squeeze position shown in FIG. 9.

FIG. 11 shows a front edge view of the example pipette head in FIG. 3.

FIG. 12 shows a plurality of pipette heads.

FIG. 13 illustrates an example embodiment of a process for attaching the pipette head of FIG. 3 to a pipette channel.

FIG. 14 illustrates an example embodiment of a process for removing a pipette head from a pipette channel.

### DETAILED DESCRIPTION

For the purpose of illustrating the disclosure, various embodiment are shown in the drawings. These example embodiments will now be described more fully with reference to the accompanying drawings wherein like reference numerals are used to denote like parts or portions throughout the description of the several views of the drawings.

Robotic Pipettor with Removable Pipette Head

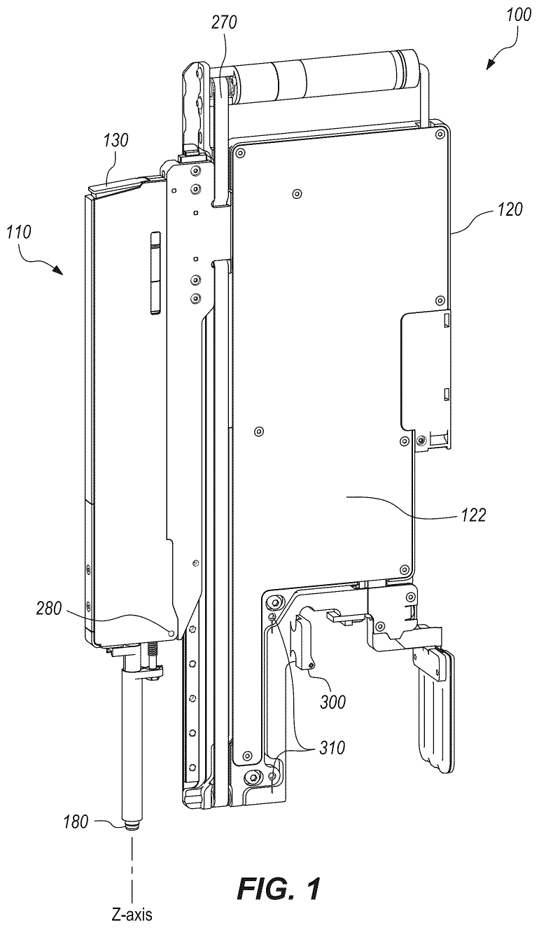

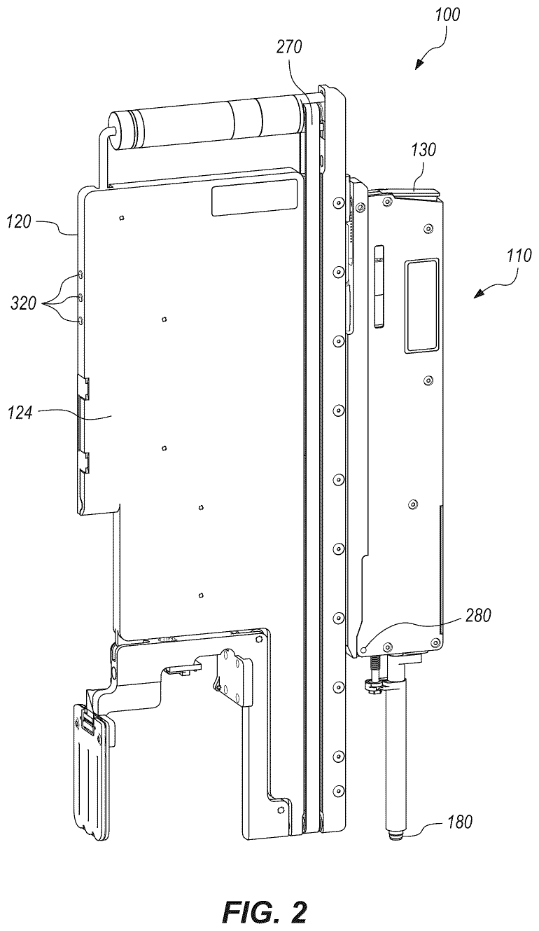

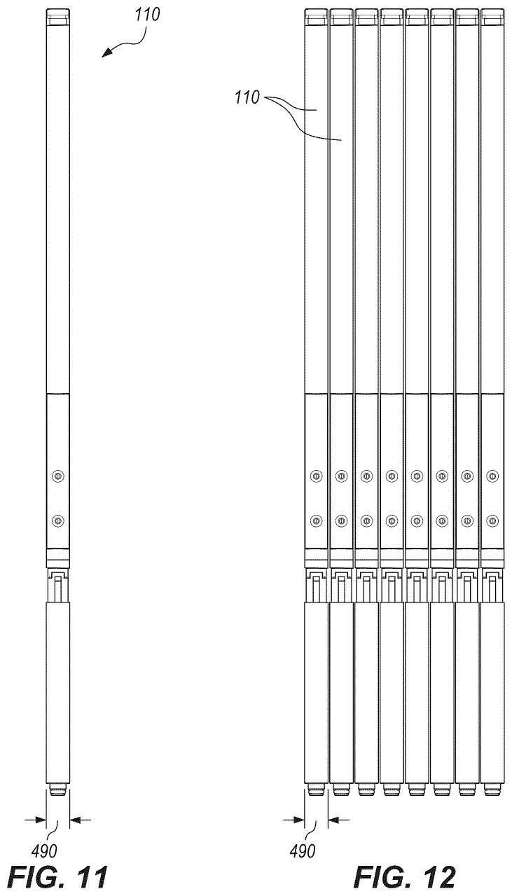

FIGS. 1 and 2 illustrate an example embodiment of a robotic pipettor 100 comprising a pipette head 110 and a pipette channel 120. Pipette channel 120 is also referred to herein as main body 120. The user can remove pipette head 110 from pipette channel 120 and replace pipette head 110 with another pipette head 110 without the use of tools. As shown in FIG. 11, a width 490 of pipette head 110 is less than or equal to 9 mm wide. A plurality of pipette heads 110 can be nested next to each other on spacing less than or equal to 9 mm in robotic pipetting systems.

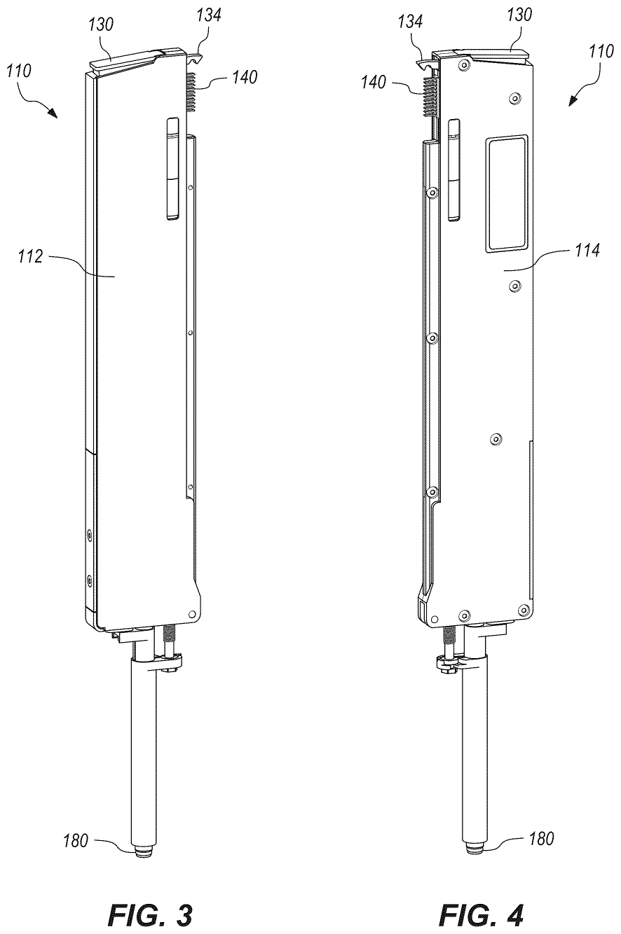

Pipette head 110 comprises a head electrical connector 140 (FIGS. 3 and 4) that fit in pipette head 110 for use in robotic pipetting systems with spacing less than or equal to 9 mm. Latch 130 can be operated manually. Pipette head 110 is a small format head, which means the head is small enough for use in 9 mm spacing without the need to offset the heads relative to each other.

In an example embodiment, pipette head 110 is 8.25 mm wide.

As shown in FIG. 12, each of a plurality of pipette heads 110 can be attached to a pipette channel 120 using spacing less than or equal to 9 mm.

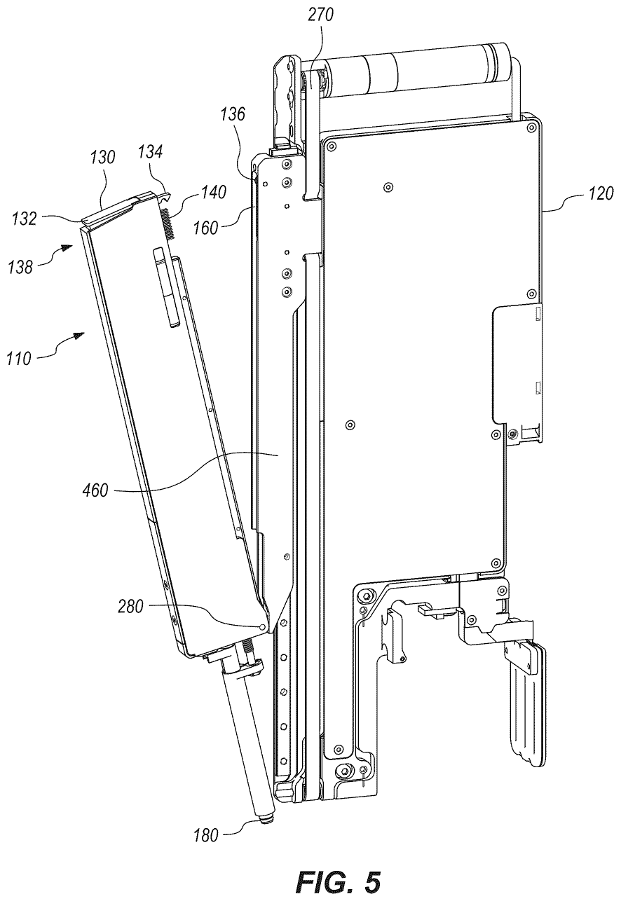

Pipette channel 120 also comprises a channel connector 160 (FIG. 5). Electrical connection is made and broken by the act of installing and removing pipette head 110 from pipette channel 120, respectively. Head electrical connector 140 fits with channel connector 160 to establish an electrical connection between pipette head 110 and pipette channel 120.

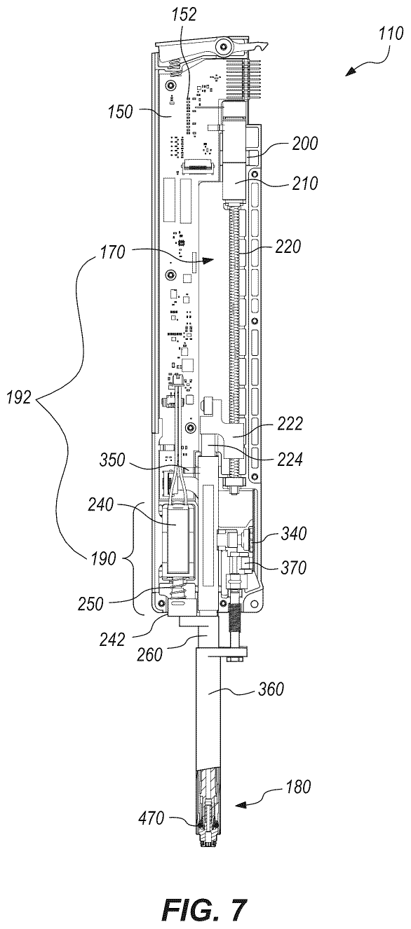

In an example embodiment, head electrical connector 140 is mounted on a printed circuit board (“PCB”) 150 (FIG. 7) to facilitate an electrical connection between pipette head 110 and pipette channel 120.

No secondary action is required for connecting pipette head 110 with pipette channel 120, and no screws are needed to hold pipette head 110 in place when connected to pipette channel 120.

As shown in FIGS. 3-5, pipette head 110 further comprises latch 130. Latch 130 comprises a push portion 132 for the user to push and a hook portion 134 for hooking over a latch striker 136 to attach a top portion 138 of pipette head 110 to pipette channel 120.

Pressing down on the push portion 132 of latch 130 raises hook portion 134 to release hook portion 134 of latch 130 from latch striker 136 which in turn allows pipette head 110 to be removed from pipette channel 120.

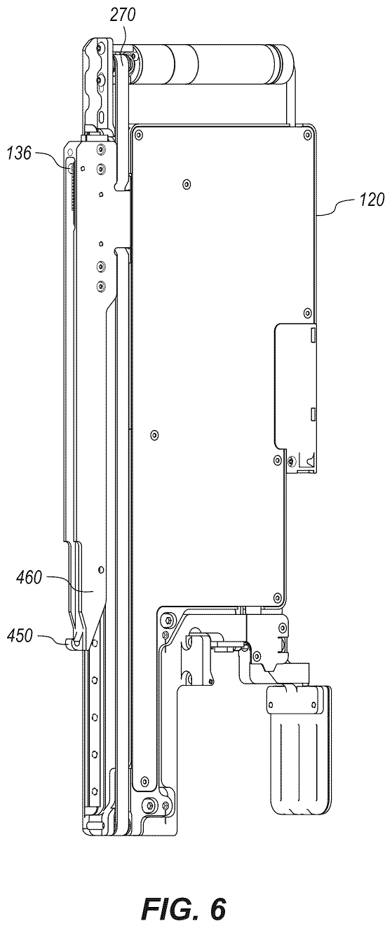

As shown in FIGS. 5-6, pipette channel 120 further comprises spine 460 with hook 450.

Pipette head 110 further comprises corner pin 280 on pipette head 110 to engage hook 450 on spine 460 to help secure pipette head 110 to pipette channel 120 and to allow pipette head 110 to be tilted away when removing pipette head 110 from pipette channel 120.

### Dispense Drive and Solenoid Squeeze Mechanism

As shown in FIG. 7, pipette head 110 further comprises dispense drive 170, tip coupling mechanism 180, and squeeze mechanism 190.

Dispense drive 170 comprises a dispense motor 200, a leadscrew 220, a leadnut 222, and a piston 224 that are small enough to fit in pipette head 110 while still providing accurate pipetting performance.

Dispense motor 200 comprises a gearbox 210.

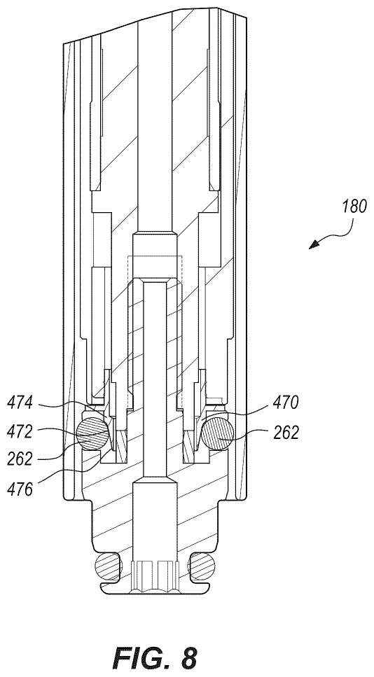

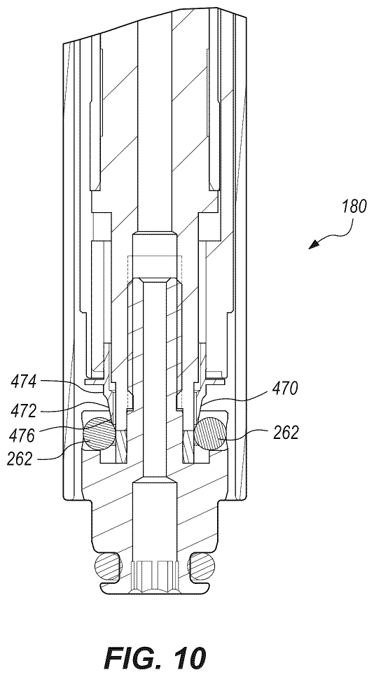

Squeeze mechanism 190 comprises a solenoid 240 to move a drive ring 470 (FIGS. 8 and 10) of tip coupling mechanism 180, such as Hamilton's CORE II and its variants, and a solenoid coupler 242. The small size of solenoid 240 and dispense motor 200 enables pipette head 110 to nest on 9 mm spacing with other pipette heads 110.

Squeeze mechanism 190 further comprises spring 250, and squeeze sleeve 260. Squeeze sleeve 260 further comprises a drive ring 470 as shown in FIGS. 8 and 10.

In an example embodiment, squeeze sleeve 260 is plastic and drive ring 470 is made using a resilient material.

Drive ring 470 has a circumferentially continuous exterior surface 472 such that the diameter of the upper portion 474 of exterior surface 472 has a larger diameter than the diameter of the lower portion 476 of exterior surface 472.

In an example embodiment, solenoid 240 is 7 mm wide and dispense motor 200 is 8 mm wide.

Mechanical components of dispense drive 170, mechanical components of squeeze mechanism 190, and mechanical components of pipette tip coupling mechanism 180 (not shown) are incorporated on pipette head 110.

In an example embodiment, electrical components 152 are mounted on printed circuit board 150. Electrical components 152 can include components such as a CPU, power supplies, and motor driver chips.

To incorporate mechanical components of dispense drive 170 and tip coupling mechanism 180 in pipette head 110 requires a better mechanical advantage than prior designs because of the small format of pipette head 110.

In an example embodiment, a better mechanical advantage is achieved wherein dispense motor 200 of dispense drive 170 is a brushless DC motor, such as a Maxon brushless DC motor, capable of higher RPMs than previous brushed DC motors. Gearbox 210 is a 4-to-1 reduction gearbox to achieve the torque required to turn leadscrew 220 and move piston 224.

In this example embodiment, the angle of drive ring 470 is 11 degrees, plus or minus accepted tolerances, to gain a mechanical advantage and allow the use of solenoid 240 instead of a stepper motor or brushed DC motor.

In an example embodiment, drive ring 470 is similar to a Hamilton CORE II wedge.

This example embodiment allows use of a smaller dispense motor 200 and solenoid 240 than in prior designs by gaining more mechanical advantage and better efficiency

Further, in this embodiment, because the pipette head is less than or equal to 9 mm, any number of pipette heads can nest next to each other on 9 mm spacing.

### Detailed Description of Mechanical Configuration

FIG. 7 shows pipette head 110 in the squeeze position, and FIG. 8 shows an enlarged view of pipette tip coupling mechanism 180 of pipette head 110 in the squeeze position. To place the pipette head 110 in the squeeze position, solenoid 240 applies pressure to spring 250 which presses down on solenoid coupler 242 and which in turn pushes down on squeeze sleeve 260. Squeeze sleeve 260 then pushes down on drive ring 470 to retain a pipette tip (not shown) in place.

The squeeze position is considered the natural state of squeeze mechanism 190.

The only time pipette head 110 moves to the un-squeeze position is when traversing in or out of a pipette tip. Moving pipette head 110 to the un-squeeze position is controlled by activating solenoid 240.

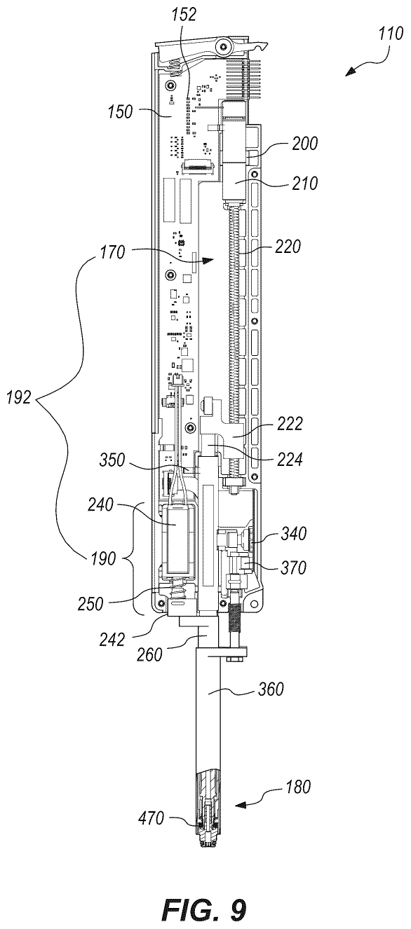

FIG. 9 shows pipette head 110 in the un-squeeze position, and FIG. 10 shows an enlarged view of pipette tip coupling mechanism 180 of pipette head 110 in the un-squeeze position. To place pipette head 110 in the un-squeeze position, solenoid 240 lifts up solenoid coupler 242 which pulls squeeze sleeve 260 up. This in turn pulls drive ring 470 up, allowing pipette tip coupling mechanism 180 to move into the pipette tip or retract from the pipette tip.

In an example embodiment, squeeze sleeve 260, solenoid coupler 242, spring 250, and drive ring 470 move approximately 1.2 mm in the un-squeeze position relative to the squeeze position.

In an example embodiment, pipette tip coupling mechanism 180 is similar to a CORE II tip coupler with spherical balls 262, also referred to herein as ball bearings, as described in U.S. Pat. No. 10,272,425, which is incorporated herein by reference.

A difference in the present disclosure relative to CORE II is that drive ring 470 of the present disclosure is attached to the squeeze sleeve 260. In CORE II, a drive ring, which is referred to as a wedge in CORE II, is not attached to a squeeze sleeve. Therefore, in CORE II when the squeeze sleeve is lifted to the un-squeeze position, the drive ring can remain in the squeeze position. In the present disclosure, when squeeze sleeve 260 is lifted, attached drive ring 470 is also lifted, so drive ring 470 cannot remain in the squeeze position. Another difference is that drive ring 470 of the present disclosure has a smaller angle than the wedge in CORE II. In one example embodiment, drive ring 470 of the present disclosure has an angle of eleven (11) degrees.

In this embodiment, when placing the pipette head 110 in the squeeze position, squeeze sleeve 260 pushes down on drive ring 470, and drive ring 470 pushes ball bearings 262 outward to retain a pipette tip (not shown).

Unlike in CORE II, in this example embodiment, when placing pipette head 110 in the un-squeeze position, drive ring 470 pulls up which allows the ball bearings 262 to retract to allow the pipette tip coupling mechanism 180 to move into or retract from a pipette tip.

In an example embodiment, dispense motor 200 of dispense drive 170 comprises a brushless DC motor, and gearbox 210 is attached to the end of the brushless DC motor.

In an example embodiment, dispense drive 170 is an 8 mm dispense drive, dispense motor 200 is a brushless DC motor is capable of 32,000 RPM and can run at 3,000-14,000 RPM, gearbox 210 is a 4-to-1 (4:1) gearbox, and leadscrew 220 is a 1 mm pitch leadscrew that is sixty-one percent (61%) efficient.

### Z Axis

Movement of pipette head 110 in the Z axis (FIG. 1) is controlled using a timing belt drive 270. In an example embodiment, pipette head 110 can travel a distance of 200 mm along the Z axis. This ability to move pipette head 110 along the Z axis provides accurate control of force and bottom search functionality.

### Adjustable Tilt and Offset

As shown in FIG. 1, robotic pipettor 100 further comprises a tilt adjuster 300 and a tilt-and-offset adjuster 310 to align pipette channel 120 on the robotic pipetting system.

Robotic pipettor 100 further comprises a tilt adjuster 300 used to align the z-axis in a first direction and two tilt-and-offset adjusters 310 to align the z-axis in a second direction. Tilt-and-offset adjusters 310 can be moved simultaneously to achieve an offset adjustment or individually to achieve a tilt adjustment. Together tilt adjuster 300 and tilt-and-offset adjusters 310 are used to align pipette channel 120 on robotic pipettor 100.

In one embodiment, tilt adjuster 300 and offset adjuster 310 are precision adjusters to further aid in alignment of adjacent channels.

### Status Lights

Turning back to FIG. 2, in an example embodiment, robotic pipettor 100 comprises a status light 320 on pipette channel 120.

In another example embodiment, robotic pipettor 100 comprises a plurality of status lights 320.

### Additional Robotic Pipettor Features

In an example embodiment shown in FIG. 7, robotic pipettor 100 further comprises pressure sensor 340, capacitive sensor 350, tip ejector 360, and tip sensor 370.

Pressure sensor 340 and capacitance sensor 350 are used for pipette monitoring and liquid level detection. Tip ejector 360 is used to push off a tip when tip coupling mechanism 180 is moved to the un-squeeze position. Tip sensor 370 is used to detect whether a tip is present.

Additional features may include qualitative pipette monitoring, liquid class definitions, liquid level detection, liquid following, search bottom, container geometry definitions, soft tip pickup and eject. In addition, robotic pipettor 100 may be CORE II compatible and be capable of ejecting a tip with fluid.

### Head Attachment Process

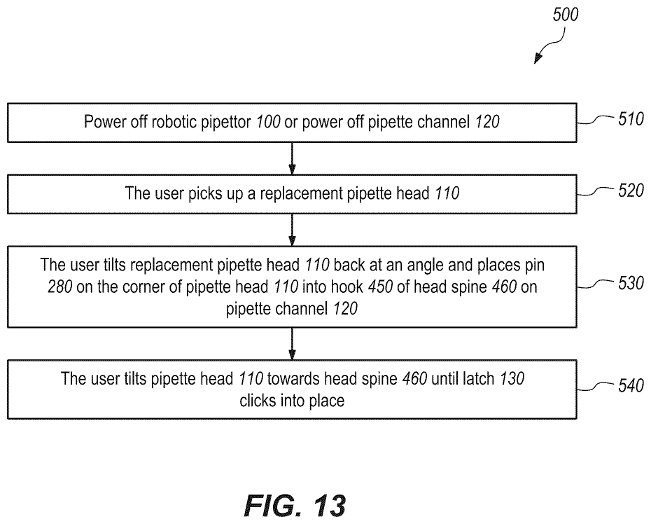

FIG. 13 illustrates an example embodiment of attachment process 500 for attaching pipette head 110 to pipette channel 120.

At Step 510, robotic pipettor 100 is powered off. In an alternate embodiment of Step 510, pipette channel 120 can be powered off instead of powering off the entire robotic pipettor 100. Attachment process 500 then moves to Step 520.

At Step 520, the user picks up a pipette head 110. Attachment process 500 then moves to Step 530.

At Step 530, the user tilts replacement pipette head 110 back at an angle and places corner pin 280 on the corner of pipette head 110 into hook 450 of spine 460 on pipette channel 120. Attachment process 500 then moves to Step 540.

At Step 540, the user tilts pipette head 110 towards spine 460 until latch 130 clicks into place.

### Head Removal Process

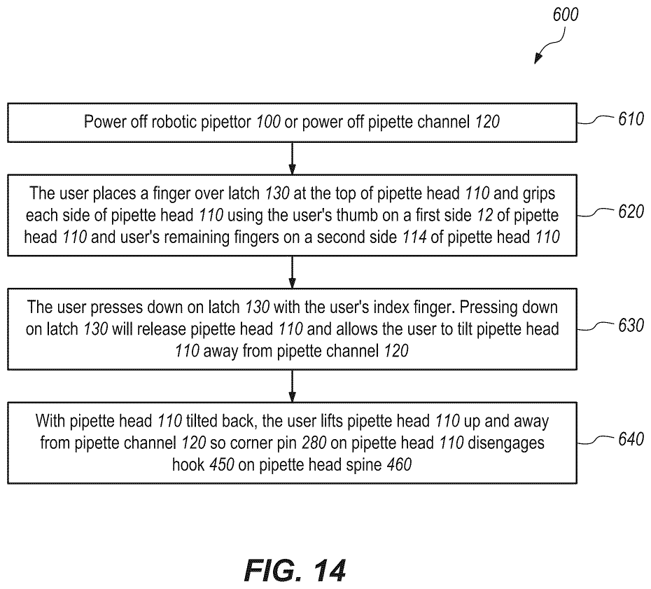

FIG. 14 illustrates an example embodiment of removal process 600 for removing pipette head 110 from pipette channel 120.

At Step 610, robotic pipettor 100 is powered off. In an alternate embodiment of Step 610, pipette channel 120 can be powered off instead of powering off the entire robotic pipettor 100. Removal process 600 then moves to Step 620.

At Step 620, a user places a finger, such as the index finger, over latch 130 at the top of pipette head 110 and grips each side of pipette head 110.

A lefthanded user can use their thumb on a first side 112 of pipette head 110 and their remaining fingers on a second side 114 of pipette head 110 to grip pipette head 110.

A righthanded user can use their thumb on the second side 114 of pipette head 110 and their remaining fingers on first side 112 of pipette head 110 to grip pipette head 110. Removal process 600 then moves to Step 630.

At Step 630, the user presses down on latch 130. Pressing down on latch 130 releases pipette head 110 and allows the user to tilt pipette head 110 away from pipette channel 120.

Removal process 600 then moves to Step 640.

At Step 640, with pipette head 110 tilted back, the user lifts pipette head 110 up and away from pipette channel 120 so corner pin 280 on pipette head 110 disengages hook 450 on spine 460.

What is claimed is:

1—A robotic pipettor comprising:
a pipette head comprising:
a width;
a pipette channel; and
wherein the pipette head can be removed from the pipette channel without the use of tools.

2—The robotic pipettor of claim 1, the pipette head further comprising:
a latch;
a head electrical connector; and
wherein the latch can be operated manually.

3—The robotic pipettor of claim 2 further comprising:
the pipette head further comprising:
a top portion;
the latch further comprising:
a push portion; and
a hook portion;
the pipette channel further comprising:
a latch striker; and
wherein the push portion of the latch moves the hook portion of the latch; and wherein the hook portion of the latch hooks over the latch striker of the pipette channel to attach the top portion of the pipette head to the pipette channel.

4—The robotic pipettor claim 2, the pipette head further comprising:
a printed circuit board; and
wherein the head electrical connector is mounted on the printed circuit board.

5—The robotic pipettor of claim 2 further comprising:
the pipette channel further comprising:
a channel connector; and
wherein the head electrical connector connects with the channel connector to establish an electrical connection between the pipette head and the pipette channel.

6—The robotic pipettor of claim 2 further comprising:
the pipette channel further comprising:
a spine comprising:
a hook;
the pipette heard further comprising:
a corner pin; and
wherein the corner pin on the pipette head engages with the hook on the spine of the pipette channel to secure the pipette head to the pipette channel and to allow the pipette head to tilt away from the pipette channel when removing the pipette head from the pipette channel.

7—The robotic pipettor of claim 1, the pipette head further comprising:
a dispense drive comprising:
a dispense motor comprising:
a gearbox;
a lead screw;
a leadnut; and
a piston;
a tip coupling mechanism; and
a squeeze mechanism comprising:
a solenoid;
a solenoid coupler;
a spring; and
a squeeze sleeve.

8—The robotic pipettor of claim 7 wherein the solenoid has a width less than or equal to 7 mm and the dispense motor has a width less than or equal to 8 mm.

9—The robotic pipettor of claim 7 wherein the dispense drive is a brushless DC motor and the gearbox is a 4 to 1 reduction gearbox.

10—The robotic pipettor of claim 1, the pipette head further comprising:
a drive ring comprising:
an angle; and
wherein the angle is 11 degrees.

11—The robotic pipettor of claim 1 wherein the pipette head has a width less than or equal to 9 mm.

12—The robotic pipettor of claim 11 wherein the pipette head is 8.25 mm wide.

13—A robotic pipettor comprising:
a plurality of pipette heads, each pipette head in the plurality of pipette heads comprises:
a pipette channel; and
a width;
wherein each pipette head of the plurality of pipette heads can be removed from the pipette channel without the use of tools; and
wherein the spacing between neighboring pipette heads in the plurality of pipette heads is less than or equal to 9 mm.

14—A method for connecting a pipette head to a pipette channel comprising:
tilting a pipette head back at an angle from a spine of a pipette channel;
placing a corner pin of the pipette head onto a hook of a spine of the pipette channel; and
tilting the pipette head towards the spine of the pipette channel until a latch connects with a latch striker and clicks into place.

15—A method for removing a pipette head to a pipette channel comprising:
powering off a pipette channel;
pressing a latch on the pipette head to release the pipette head from the pipette channel;
tilting the pipette head away from the pipette channel; and
lifting the pipette head up and away from the pipette channel to disengage a corner pin of the pipette head from a hook on a spine of the pipette channel.
